(19) United States
(12) Patent Application Publication
(10) Pub. No.: US 2016/0080561 A1
(43) Pub. Date: Mar. 17, 2016

(54) METHOD AND NOTIFICATION SYSTEM FOR PROVIDING A NO-ANSWER NOTIFICATION TO A CALLER

(71) Applicant: JUNG-TSUNG WEI, TAINAN CITY (TW)

(72) Inventor: JUNG-TSUNG WEI, TAINAN CITY (TW)

(21) Appl. No.: 14/853,394

(22) Filed: Sep. 14, 2015

(30) Foreign Application Priority Data
Sep. 15, 2014 (TW) 103131759

(51) Int. Cl. H04M 3/42; H04W 4/16

(52) U.S. Cl. CPC H04M 3/42093; H04W 4/16

(57) ABSTRACT

A method for providing a no-answer notification to a caller is to be implemented by a notification system that includes a mobile device. In the method, the mobile device is programmed to: start timing upon receiving an incoming call signal at the mobile device from a communication device acting as a caller; determine whether the mobile device is in a silent mode, in which a ringtone is not generated in response to the incoming call signal; and when it is determined that the mobile device is in the silent mode, transmit to the communication device a no-answer notification indicating that the mobile device is in the silent mode after the incoming call signal is unanswered for a predetermined time period.

### CROSS-REFERENCE TO RELATED APPLICATION

This application claims priority of Taiwanese Application No. 103131759, filed on Sep. 15, 2014.

### FIELD

The disclosure relates to a method and a notification system for providing a no-answer notification to a caller.

### BACKGROUND

As mobile technologies progress, most of the population are equipped with mobile devices for communicating with other people. One way for the communication is a voice call initiated by a caller to a receiver. Typically, a voice call cannot be established until the receiver “answers” the call.

It is noted that the receiver may not always be available for answering the voice call. For example, when the receiver is busy (e.g., at a conference, driving or other occasions), at rest, or in other situations, an incoming call for the receiver may be overlooked due to the receiver configuring his/her mobile device to a silent mode, in which a ringtone is not generated in response to the incoming call.

When the incoming call is unanswered for a period, the call becomes a missed call, which may frustrate the caller and cause unnecessary misunderstandings between the receiver and the caller.

### SUMMARY

Therefore, an object of the disclosure is to provide a method for providing a no-answer notification to a caller.

According to the disclosure, the method is to be implemented by a notification system including a mobile device, and includes the steps of:

a) starting timing upon receiving an incoming call signal at the mobile device from a communication device acting as a caller;

b) determining whether the mobile device is in a silent mode, in which a ringtone is not generated in response to the incoming call signal; and

c) when it is determined in step b) that the mobile device is in the silent mode, transmitting to the communication device a no-answer notification indicating that the mobile device is in the silent mode after the incoming call signal is unanswered for a predetermined time period.

Another object of the disclosure is to provide a system for implementing the above-mentioned method.

According to the disclosure, the notification system is embodied in at least one of a mobile device and an intermediate device coupled to the mobile device. The notification system includes a mode detecting module embodied in one of the mobile device and the intermediate device, a timer module, and a notification module.

Upon receiving an incoming call signal from a communication device acting as a caller, the timer module is programmed to start timing. The mode detecting module is programmed to determine whether the mobile device is in a silent mode, in which a ringtone is not generated in response to the incoming call signal.

When it is determined that the mobile device is in the silent mode, the notification module is programmed to transmit, to the communication device, a no-answer notification indicating that the mobile device is in the silent mode after the incoming call signal is unanswered for a predetermined time period.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a first embodiment of a notification system according to the disclosure;

FIG. 2 is a flow chart illustrating steps of a method for providing a no-answer notification to a caller, to be implemented by the notification system of the first embodiment;

FIG. 3 is a block diagram illustrating a notification system according to a second embodiment of the disclosure;

FIG. 4 is a flow chart illustrating steps of a method for providing a no-answer notification to a caller, to be implemented by the notification system of the second embodiment;

FIG. 5 is a block diagram illustrating a notification system according to a variation of the second embodiment; and

FIG. 6 is a block diagram illustrating a notification system according to another variation of the second embodiment.

### DETAILED DESCRIPTION

Before the disclosure is described in greater detail, it should be noted that like elements are denoted by the same reference numerals throughout the disclosure.

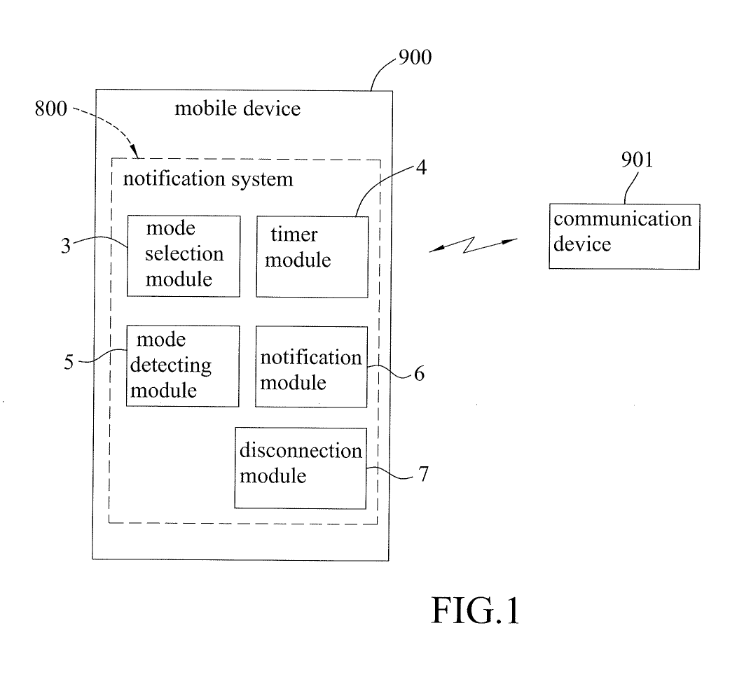

FIG. 1 illustrates a notification system 800 for providing a no-answer notification to a caller, according to a first embodiment of the disclosure.

In this embodiment, the notification system 800 is embodied in a mobile device 900 for communicating with a communication device 901 acting as a caller.

The mobile device 900 is capable of operating a voice call with the communication device 901, and may be embodied using a mobile phone, a smart watch, a tablet computer, a laptop computer, a Google Glass, etc.

The notification system 800 may be embodied using a chip implemented with a software application, and includes a mode selection module 3, a timer module 4, a mode detecting module 5, a notification module 6 and a disconnection module 7.

The mode selection module 3 enables a user of the mobile device 900 to switch the mobile device 900 between a sound mode and a silent mode. In this embodiment, when the mobile device 900 is in the sound mode, a ringtone will be generated and outputted in response to an incoming call signal from the communication device 901. When in the silent mode, the mobile device 900 does not generate the ringtone in response to the incoming call signal. Instead, the mobile device 900 may employ other manners to notify the user of the incoming call signal, such as through vibration, a displayed message, etc.

In some embodiments, the mode selection module 3 may enable the user to switch to the silent mode, and automatically switch to the sound mode after a preset time period (e.g., 2 or 5 hours).

When an incoming call signal from the communication device 901 is received by the mobile device 900, the timer module 4 is activated to start timing anew, and the mode detecting module 5 is programmed to determine whether the mobile device 900 is in the silent mode. In some embodiments, the timer module 4 maybe programmed to control a timer built in the mobile device 900 for timing.

When it is determined that the mobile device 900 is in the sound mode, the notification system 800 allows the mobile device 900 to handle the incoming call signal as normal (i.e., produce the ringtone to notify the user).

On the other hand, when it is determined that the mobile device 900 is in the silent mode, the mode detecting module 5 is programmed to detect an activation time when the silent mode is activated, and transmit a no-answer signal to the notification module 6.

Upon receipt of the no-answer signal (meaning that the electronic device 900 is in the silent mode), the notification module 6 is programmed to compose a no-answer notification after the incoming call signal is not answered for a predetermined time period (e.g., 5 seconds) that is set by the user (i.e., after the timer module 4 has timed the predetermined time period by which instant the incoming call remains unanswered). In some embodiments, the predetermined time period may be set at zero. In such a case, the timer module 4 maybe omitted, and the notification module 6 is programmed to immediately compose the no-answer notification.

The no-answer notification is then transmitted directly to the communication device 901 in order to notify the caller that the mobile device 900 is currently in the silent mode, and that the user of the mobile device 900 may be unable to answer the incoming call. In some embodiments, the no-answer notification includes the activation time detected by the mode detecting module 5. For example, the no-answer notification may be in the form of a voice clip stating “The number you called has been in silent mode since 7:00 AM”. As a result, the caller may be notified that the user is currently unavailable. In various embodiments, the no-answer notification may include a text message, a voice message, an image, or a combination thereof.

The disconnection module 7 is programmed to cut off the incoming call signal, and to disconnect the mobile device 900 from the communication device 901 after the no-answer notification is transmitted. In other embodiments, the disconnection module 7 may be programmed to direct the caller to leave a message in the voicemail of the mobile device 900.

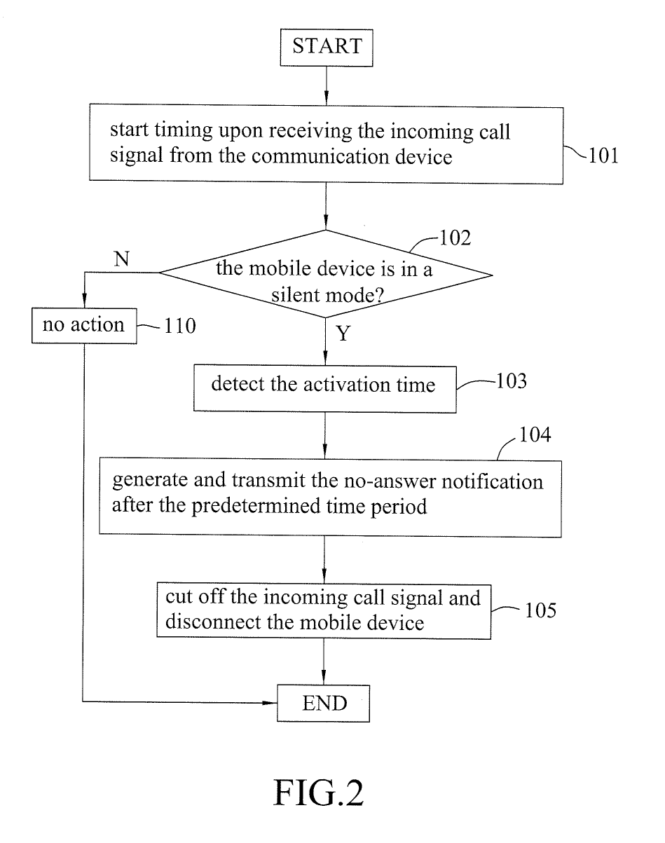

FIG. 2 illustrates steps of a method for providing a no-answer notification to a caller that is to be implemented by the notification system 800.

In step 101, upon receiving the incoming call signal from the communication device 901, the timer module 4 is activated to start timing anew.

In step 102, the mode detecting module 5 determines whether the mobile device 900 is in a silent mode. When the determination in step 102 is affirmative, the flow proceeds to step 103. Otherwise, the flow proceeds to step 110, in which the notification system 800 takes no action, and allows the mobile device 900 to handle the incoming call signal as normal.

In step 103, the mode detecting module 5 detects the activation time.

In step 104, after it is determined that the incoming call signal is unanswered for the predetermined time period as timed by the timer module 4, the notification module 6 generates and transmits the no-answer notification to the communication device 901.

In step 105, the disconnection module 7 cuts off the incoming call signal, and disconnects the mobile device 900 from the communication device 901.

In brief, the method and notification system of this embodiment are capable of determining whether the user is available for answering an incoming call signal (by detecting which mode the mobile device 900 is in, and to calculate the time for which the user does not answer the incoming call signal), and to transmit the no-answer notification to the communication device 901 when it is determined that the user is not available. In this way, the caller may be assured that his/her call is not intentionally unanswered, and may likely rule out the situations that something bad has happened to the user.

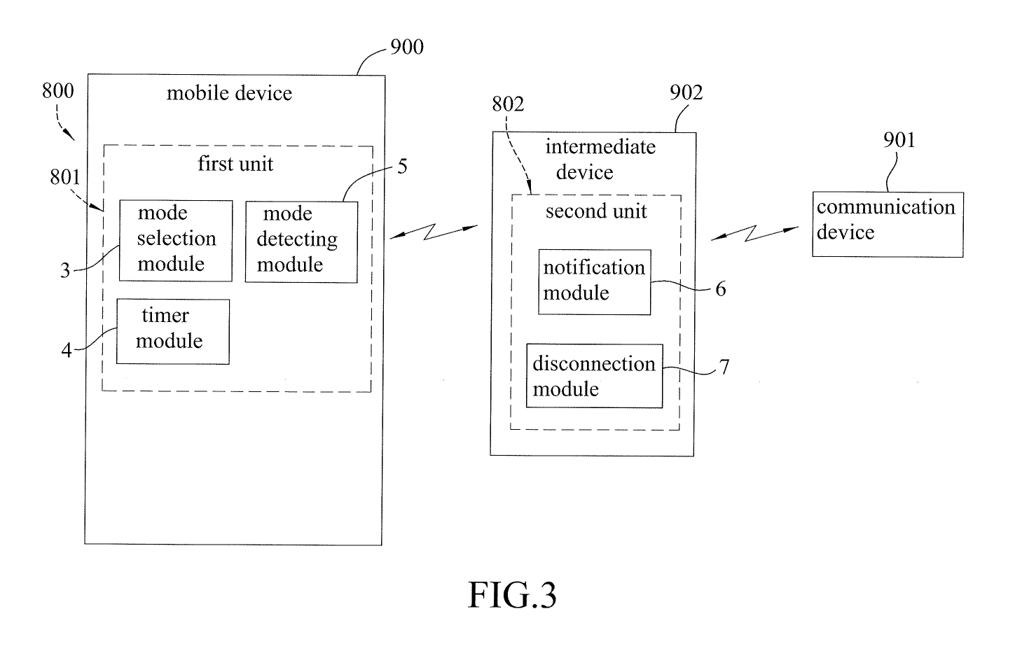

FIG. 3 illustrates a second embodiment of the notification system 800 according to the disclosure. In this embodiment, the notification system 800 is embodied in the mobile device 900 and an intermediate device 902 coupled to the mobile device 900. The intermediate device 902 may be embodied using a server provided by a telephony provider or a voice over IP (VoIP) provider, and is configured to enable communication between the mobile device 900 and the communication device 901.

The notification system 800 includes a first unit 801 and a second unit 802. The first unit 801 is embodied in the mobile device 900, and the second unit 802 is embodied in the intermediate device 902.

The first unit 801 includes the mode selection module 3, the timer module 4 and the mode detecting module 5. The second unit 802 includes the notification module 6 and the disconnection module 7.

In use, the incoming call signal from the communication device 901 is received by the intermediate device 902. Upon receipt of the incoming call signal, the intermediate device 902 relays the same to the mobile device 900.

In response to the incoming call signal, the timer module 4 starts timing anew, and the mode detecting module 5 detects which mode the mobile device 900 is in.

When it is determined that the mobile device 900 is in the silent mode, the mode detecting module 5 is programmed to generate the no-answer signal after the predetermined time period during which the incoming call signal is unanswered, and to transmit the no-answer signal to the intermediate device 902. In some embodiments, the mode detecting module 5 may further detect the activation time and to incorporate the activation time in the no-answer signal.

In response to the no-answer signal, the notification module 6 embodied in the intermediate device 902 is programmed to compose the no-answer notification, and to transmit the same to the communication device 901. The disconnection module 7 is programmed to cut off the incoming call signal, and to disconnect the mobile device 900 from the communication device 901 (i.e., to stop transmitting the incoming call signal to the mobile device 900).

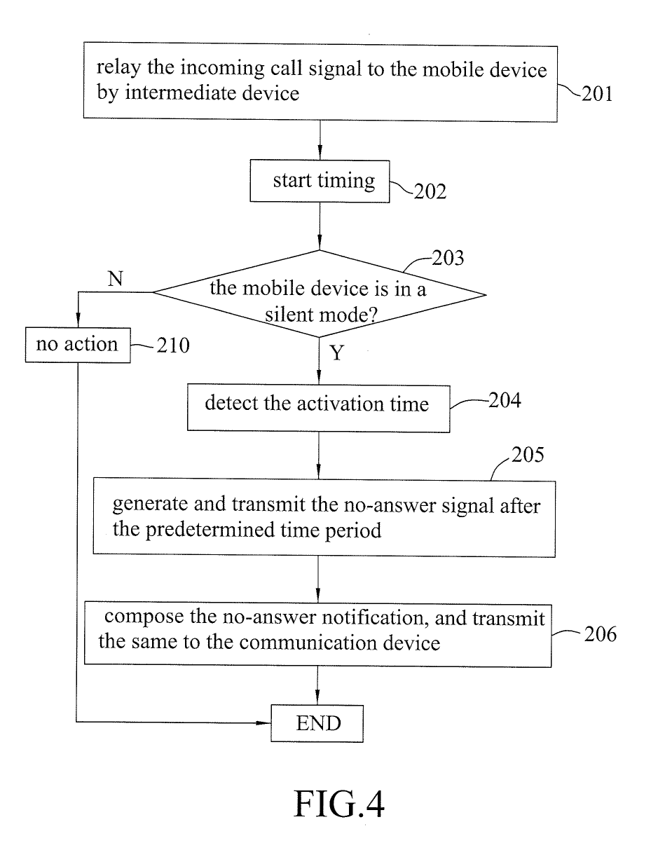

FIG. 4 illustrates steps of a method for providing a no-answer notification to a caller that is to be implemented by the notification system 800, according to the second embodiment of the disclosure.

In step 201, upon receiving the incoming call signal from the communication device 901, the intermediate device 902 relays the incoming call signal to the mobile device 900.

In step 202, upon receiving the incoming call signal from the communication device 901, the timer module 4 is activated to start timing anew.

In step 203, the mode detecting module 5 determines whether the mobile device 900 is in a silent mode. When the determination in step 203 is affirmative, the flow proceeds to step 204. Otherwise, the flow proceeds to step 210, in which the notification system 800 takes no action, and allows the mobile device 900 to handle the incoming call signal as normal.

In step 204, the mode detecting module 5 detects the activation time.

In step 205, after it is determined that the incoming call signal is unanswered for the predetermined time period as timed by the timer module 4, the mode detecting module 5 generates and transmits the no-answer signal to the communication device 901.

In step 206, the notification module 6 composes the no-answer notification, and transmits the same to the communication device 901.

In step 207, the disconnection module 7 cuts off the incoming call signal, and disconnects the mobile device 900 from the communication device 901.

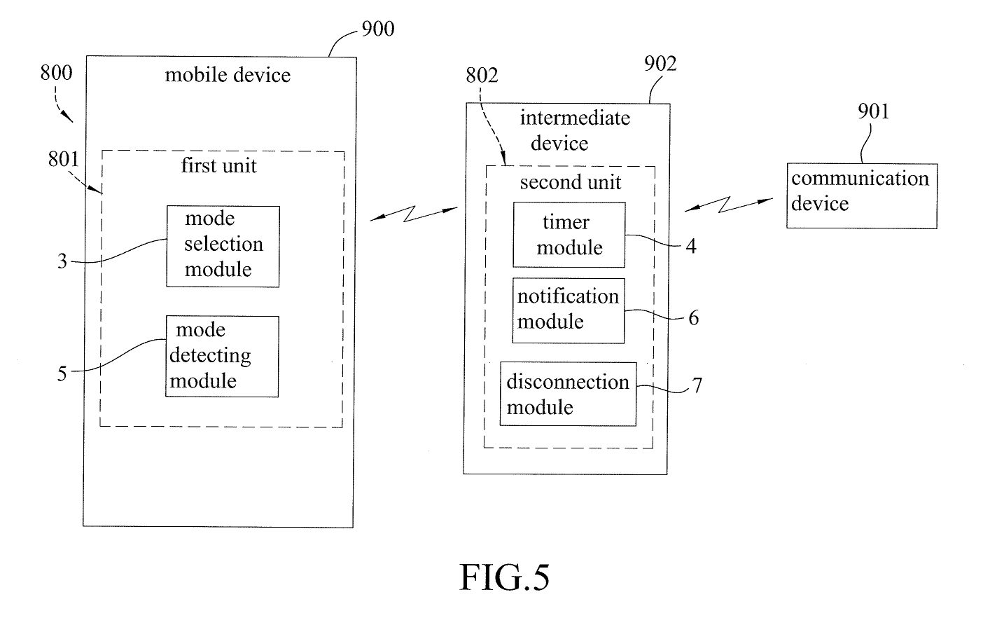

FIG. 5 illustrates the notification system 800, according to a variation of the second embodiment.

In this variation, the first unit 801 includes the mode selection module 3 and the mode detecting module 5. The second unit 802 includes the timer module 4, the notification module 6 and the disconnection module 7.

In use, the incoming call signal from the communication device 901 is received by the intermediate device 902. In turn, the intermediate device 902 relays the incoming call signal to the mobile device 900, and the timer module 4 starts timing anew.

In response to the incoming call signal, the mode detecting module 5 detects which mode the mobile device 900 is in.

When it is determined that the mobile device 900 is in the silent mode, the mode detecting module 5 is programmed to generate the no-answer signal, and to transmit the no-answer signal to the intermediate device 902 immediately. In some embodiments, the mode detecting module 5 may further detect the activation time and to incorporate the activation time in the no-answer signal.

In response to the no-answer signal, the notification module 6 composes the no-answer notification and transmits the same to the communication device 901 after the predetermined time period has elapsed and the incoming call signal remains unanswered. The disconnection module 7 then cuts off the incoming call signal and disconnects the mobile device 900 from the communication device 901.

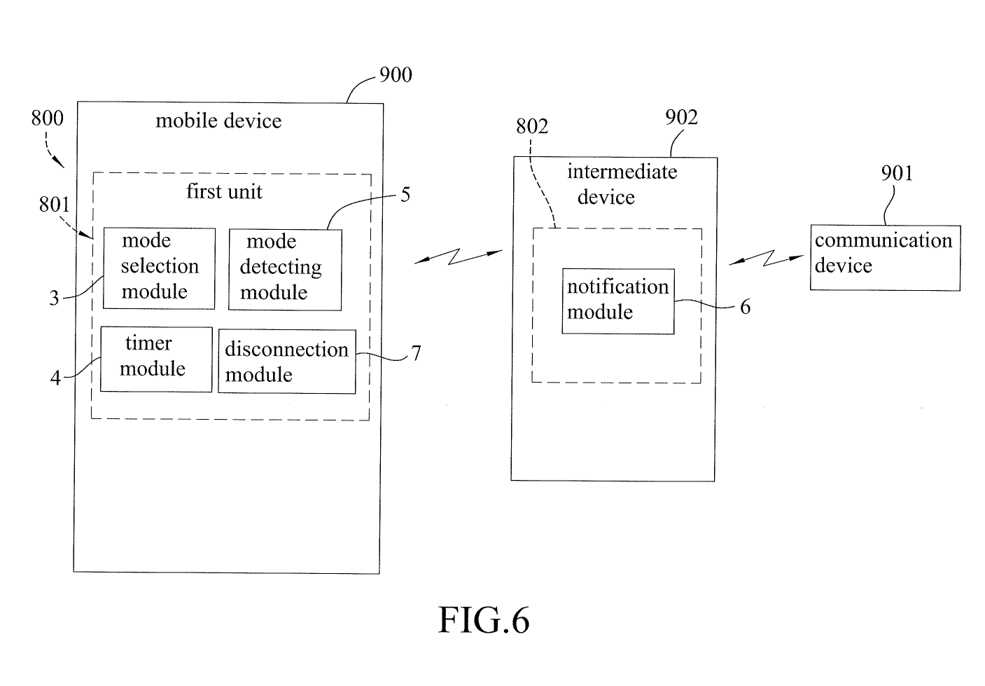

FIG. 6 illustrates the notification system 800, according to another variation of the second embodiment.

In this variation, the first unit 801 includes the mode selection module 3, the mode detecting module 5, the timer module 4 and the disconnection module 7. The second unit 802 includes the notification module 6.

In use, the incoming call signal from the communication device 901 is received by the intermediate device 902. In turn, the intermediate device 902 relays the incoming call signal to the mobile device 900.

In response to the incoming call signal, the timer module 4 starts timing anew, and the mode detecting module 5 detects which mode the mobile device 900 is in.

When it is determined that the mobile device 900 is in the silent mode, the mode detecting module 5 is programmed to generate the no-answer signal, and to transmit the no-answer signal to the intermediate device 902 after the predetermined time period has elapsed and the incoming call signal remains unanswered, at which time the disconnection module 7 cuts off the incoming call signal and disconnects the mobile device 900 from the communication device 901. In some embodiments, the mode detecting module 5 may further detect the activation time and to incorporate the activation time in the no-answer signal.

In response to the no-answer signal, the notification module 6 composes the no-answer notification and transmits the same to the communication device 901.

The second embodiment is therefore capable of achieving an effect similar to that of the first embodiment.

To sum up, the method and the notification system 800 as described in the disclosure enable the mobile device 900 to generate a no-answer notification to the communication device 901 when the user is not available. In this way, unnecessary misunderstandings between the user of the mobile device 900 and the caller due to the incoming called being unanswered may be avoided.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for providing a no-answer notification to a caller, the method to be implemented by a notification system including a mobile device, the method comprising the steps of:
a) starting timing upon receiving an incoming call signal at the mobile device from a communication device acting as a caller;
b) determining whether the mobile device is in a silent mode, in which a ringtone is not generated in response to the incoming call signal; and
c) when it is determined in step b) that the mobile device is in the silent mode, transmitting to the communication device a no-answer notification indicating that the mobile device is in the silent mode after the incoming call signal is unanswered for a predetermined time period.

2. The method of claim 1, further comprising the step of detecting an activation time when the silent mode is activated,
wherein the no-answer notification transmitted to the communication device includes the activation time.

3. The method of claim 1, further comprising, after step c), the steps of cutting off the incoming call signal and disconnecting the mobile device from the communication device.

4. The method of claim 1, wherein the no-answer notification includes at least one of a text message, a voice message and an image.

5. The method of claim 1, wherein, in step c), the mobile device is programmed to compose the no-answer notification, and to directly transmit the no-answer notification to the communication device.

6. The method of claim 1, wherein, in step a), the mobile device is programmed to start timing upon receiving the incoming call signal.

7. The method of claim 1, the communication device further including an intermediate device configured to enable communication between the mobile device and the communication device,
wherein, in step a), the intermediate device is programmed to receive the incoming call signal from the communication device and to transmit the incoming call signal to the mobile device.

8. The method of claim 7, wherein step c) includes the sub-steps of:
c1) transmitting, by the mobile device, a no-answer signal to the intermediate device after the incoming call signal is unanswered for the predetermined time period;
c2) composing, by the intermediate device, the no-answer notification in response to receipt of the no-answer signal; and
c3) transmitting the no-answer notification to the communication device.

9. The method of claim 7, wherein, in step a), the intermediate device is programmed to start timing upon receiving the incoming call signal.

10. A notification system for providing a no-answer notification to a caller, said notification system embodied in at least one of a mobile device and an intermediate device coupled to the mobile device, said notification system comprising a mode detecting module embodied in one of the mobile device and the intermediate device, a timer module, and a notification module,
wherein, upon receiving an incoming call signal from a communication device acting as a caller:
said timer module is programmed to start timing;
said mode detecting module is programmed to determine whether the mobile device is in a silent mode, in which a ringtone is not generated in response to the incoming call signal; and
when it is determined that the mobile device is in the silent mode, said notification module is programmed to transmit, to the communication device, a no-answer notification indicating that the mobile device is in the silent mode after the incoming call signal is unanswered for a predetermined time period.

11. The notification system of claim 10, wherein said notification module is further programmed to detect an activation time when the silent mode is activated, and the no-answer notification transmitted to the communication device includes the activation time.

12. The notification system of claim 10, further comprising a disconnection module that is programmed to cut off the incoming call signal and disconnect said mobile device from the communication device.

13. The notification system of claim 10, wherein the no-answer notification generated by said notification module includes at least one of a text message, a voice message and an image.

14. The notification system of claim 10, wherein:
said mode detecting module, said timer module, and said notification module are embodied in the mobile device;
said notification module is programmed to compose the no-answer notification, and to directly transmit the same to the communication device.

15. The notification system of claim 10, wherein said timer module is embodied in the mobile device, and is programmed to start timing upon receiving the incoming call signal.

16. The notification system of claim 10, wherein said notification module is embodied in the intermediate module, and is programmed to:
receive the incoming call signal from the communication device and to transmit the incoming call signal to the mobile device;
upon receiving a no-answer signal from the mobile device after the incoming call signal is unanswered for the predetermined time period, compose the no-answer notification in response to receipt of the no-answer signal; and
transmit the no-answer notification to the communication device.

17. The notification system of claim 16, wherein said timer module is embodied in the intermediate device, and is programmed to start timing upon receiving the incoming call signal.

18. The notification system of claim 16, further comprising a disconnection module that is embodied in the intermediate module, and that is programmed to cut off the incoming call signal and disconnect said mobile device from the communication device.
